(19) United States
(12) Patent Application Publication
(10) Pub. No.: US 2018/0086307 A1
(43) Pub. Date: Mar. 29, 2018

(54) DEVICE AND METHOD FOR MONITORING A VEHICLE, PARTICULARLY FOR THE MANAGEMENT OF LOSS EVENTS

(71) Applicant: COOLBOX S.R.L., Catania (IT)

(72) Inventors: Luca Spina, Pedara (IT); Antonio Ernesto Zangara, Catania (IT); Alessandro Francesco Calogero, Catania (IT)

(21) Appl. No.: 15/704,983

(22) PCT Filed: Feb. 10, 2016
(86) PCT No.: PCT/IB1206/050690

§ 371 Date: Dec. 12, 2017

(30) Foreign Application Priority Data
Feb. 16, 2015 (IT) MI2015A000220

(51) Int. Cl. B60R 25/30; G06K 9/00; H04N 5/247; G06T 7/11

(52) U.S. Cl. CPC B60R 25/305; G06K 9/00832; G06T 7/11; H04N 5/247; G06K 9/00771

(57) ABSTRACT

The present invention concerns a device and a method for monitoring a vehicle provided with an inner compartment at least partially delimited by a plurality of windows, particularly for the management of loss events, the monitoring device (10) comprising a central unit (11) connected to a plurality of sensors (12,13,14a,14b,15,16) adapted to detect at least one significant signal for identifying a loss event involving the vehicle, said plurality of sensors (12,13,14a,14b,15,16) comprising at least one inner video camera (14a, 14b) adapted to detect images inside and/or outside the inner compartment framed from the inside of the vehicle compartment and transmit them to the central unit (11), characterised in that the central unit (11) comprises means for processing the signals detected by the plurality of sensors (12,13,14a,14b,15,16) adapted to identify the occurrence of a loss event based on at least he signal detected by the at least one inner video camera (14a, 14b).

The present invention concerns a device and a method for monitoring a vehicle, in particular for managing loss events.

In greater detail, the present invention concerns a device and a method for monitoring a vehicle in particular able to be used to reconstruct the dynamics of a loss event, therefore being especially suitable for being used for insurance purposes and/or for theft prevention.

In the present description and in the claims, the term “loss event” means any adverse event, such as a road accident, an act of vandalism, a theft, a fire, natural events and so on.

In the present description and in the claims, the term “vehicle” means any means of transport suitable for transferring people, animals or things, with preferred but not exclusive reference to land and/or sea vehicles.

Currently, devices for monitoring a vehicle are known, also going by the name “black box”, which are capable of detecting a plurality of travel parameters including the instantaneous position of the vehicle, the instantaneous speed, the acceleration along the three main directions and so on.

The Applicant has observed that the parameters that are monitored and recorded by devices that are currently known allow only a partial reconstruction of how a dynamic loss event happened, not always being suitable for providing an unequivocal interpretation of the recorded data.

In the present description and in the claims, the expression “dynamic loss event ” means a loss event that takes place while the vehicle is in motion or in any case turned on. An example of dynamic loss events are road accidents.

The Applicant has also observed that the devices that are currently known only detect parameters relative to the moving dynamics of the vehicle, therefore not being suitable for identifying loss events that take place while the vehicle is stopped and parked, i.e. when the vehicle is turned off and locked, like for example a theft, a fire or an act of vandalism.

In the present description and in the claims, such loss events will be indicated by the expression “static loss event”.

Concerning this, the alarm systems currently used are generally equipped with sensors capable of detecting a bang or the opening of an access point to the vehicle, in such circumstances activating a sound alarm and taking care of blocking the engine.

The parameters that can currently be detected through known devices are, however, characteristic of the fact that a theft is already in progress, possibly causing damage to the vehicle, for example during the forced opening of a door.

Such a system is known from document no. US 2010/0194884 that describes a vehicle provided with proximity sensors used to detect the occurrence of a loss event. Based on the signals detected by the sensors, specific video cameras mounted outside of the passenger compartment of the vehicle are activated in order to film a loss event while it is happening. Such document US 2010/0194884 also describes the use of video cameras mounted inside the vehicle. Such inner video cameras are used only to monitor the behaviour of the driver or to record the images of a loss event already in progress, being activated only after the detection of a loss event that is occurring.

The Applicant has therefore considered the need to make a device capable not only of monitoring a dynamic loss event in a complete manner, in order to provide a reliable reconstruction thereof, but also of identifying a static loss event already from the first steps of it being carried out, in order to be able to provide a rapid indication that can lead to the loss event itself being prevented and in some cases even preventing possible damage to the vehicle.

Document EP 2 717 571 describes a vehicle provided with a plurality of outer video cameras. The images taken by the outer video cameras are analysed in order to identify the presence of a person and therefore that a loss event is happening. Specifically, the images are analysed to identify a moving object having a height greater than a predetermined value.

The use of outer video cameras for identifying a loss event taking place, although fairly effective, can only be implemented through complex systems that foresee the use of at least four or five outer video cameras in order to ensure that the entire perimeter of the vehicle is covered. Moreover, such a system is unable to identify loss events that take place entirely inside the vehicle.

In light of the above, the problem forming the basis of the present invention is therefore that of devising a device for monitoring a vehicle that is capable of providing certainty regarding the reconstruction of the dynamics of an accident and at the same time is suitable for identifying and rapidly signalling situations leading up to a static loss event outside and/or inside the vehicle.

In accordance with a first aspect thereof, the invention concerns a device for monitoring a vehicle provided with an internal camera at least partially delimited by a plurality of windows, the monitoring device comprising a central unit connected to a plurality of sensors suitable for detecting at least one significant signal for identifying a loss event involving the vehicle, the plurality of sensors comprising at least one inner video camera suitable for detecting images inside and/or outside the compartment, taking them from inside the compartment of the vehicle and transmitting them to the central unit, characterised in that the central unit comprises means for processing the signals detected by the plurality of sensors suitable for identifying loss event is progress based at least on the signal detected by the at least one inner video camera.

In the present description and in the claims, the expression “compartment of the vehicle” means the volume inside the vehicle in which the passengers or goods can sit, like for example the passenger compartment of an automobile or the cabin of a boat.

In the present description and in the claims, the expression “plurality of windows delimiting the compartment of the vehicle” means all of the portions at least partially permeable to light foreseen in the walls that delimit an inner compartment of a vehicle. In the case of a vehicle for transporting people in which the inner compartment coincides with the passenger compartment, the windows for the purposes of the patent comprise the side windows of the vehicle, the rear window where present, and the front windscreen, considered in combination or as alternatives. In the case of a goods transportation vehicle, the term “inner compartment” means, as alternatives or in combination, either/both the driver's compartment of the lorry, and/or the volume inside a trailer closed through canvas or walls. For such vehicles, the term “windows” means the windows in the narrow sense that delimit the driver's compartment and/or the portions at least partially permeable to light present in the walls of the closed trailers.

The Applicant has observed that the information provided by the images that can be taken from inside the compartment of the vehicle is essential for quickly determining a static loss event, as well as for allowing an unequivocal reconstruction of how a dynamic loss event happened.

In particular, from inside the compartment of the vehicle, for example from the passenger compartment of an automobile, it is possible to monitor what happens near to the windows, therefore being able to identify suspect behaviour typically linked to an attempted theft or to the preliminary activities of an act of vandalism or arson.

Such images can also be decisive for the reconstruction of collisions. For example, in the case of a collision that has occurred, the images recorded through the side windows and the rear window of the vehicle provide essential information on the dynamics of the event. Similarly, in the case of frontal impact, the images taken through the side windows and the windscreen are useful for the reconstruction of the dynamics of the event.

The Applicant has equally observed that from the inside of the chamber of the vehicle it is possible to monitor the space typically occupied by the passengers, being able to detect the presence of children and/or animals that have been left on board.

Similarly, in accordance with a second aspect thereof, the invention concerns a vehicle provided with an inner compartment at least partially delimited by a plurality of windows characterised in that it comprises a device for monitoring a vehicle as described above.

Equally, in accordance with a third aspect thereof, the invention concerns a method for monitoring a vehicle provided with an inner compartment at least partially delimited by a plurality of windows comprising the steps consisting of detecting at least one significant signal for identifying a loss event involving the vehicle, and identifying a loss event based on the at least one signal detected, wherein the at least one significant signal for identifying a loss event involving the vehicle comprises at least one image inside and/or outside the inner comportment framed from inside the compartment of the vehicle.

Advantageously, the vehicle and the method for monitoring a vehicle according to the invention achieve the technical effects described above in relation to the device.

The present invention, in at least one of the aforementioned aspects, can have at least one of the following preferred characteristics, these in particular being able to be combined together as desired in order to satisfy specific application requirements.

Preferably, the means for processing the signals detected by the plurality of sensors adapted to identify the occurrence of a loss event based on at least the signal detected by the at least one inner video camera are adapted to implement the method for monitoring a vehicle according to the present invention.

Preferably, the at least one inner video camera can be installed so as to frame at least part of the plurality of windows delimiting the compartment of the vehicle in order to frame at least part of the outside of the vehicle from inside the compartment.

More preferably, the at least one inner video camera can be installed so as to frame at least part of the perimeter of the compartment of the vehicle from the inside.

Preferably, the at least one inner video camera can be installed so as to frame at least part of the inside of the compartment of the vehicle. Preferably, the at least one inner video camera can be installed at a rear-view mirror of the vehicle.

More preferably, the at least one inner video camera comprises a wide-angle lens.

Alternatively, the at least one inner video camera is a fish-eye video camera, capable of taking 360° images.

Preferably, the plurality of sensors comprises at least one first and a second inner video camera, where the first inner video camera can be installed so as to frame at least part of the side windows and of the rear window delimiting the side and rear of the compartment of the vehicle from inside said compartment of the vehicle, and the second inner video camera can be installed so as to frame at least part of the windscreen delimiting the front of the compartment of the vehicle from inside said compartment of the vehicle.

More preferably, the first inner video camera can be installed so as to frame at least part of the inside of the compartment of the vehicle.

Preferably, the plurality of sensors comprises at least one sound sensor for installation inside the compartment of the vehicle.

More preferably, the sound sensor is of the high-sensitivity type in order to capture even sounds coming from outside the compartment of the vehicle.

Preferably, the plurality of sensors comprises at least one sensor among the sensors selected from the group consisting of:

a motion sensor;

a location sensor;

an acceleration sensor;
a speedometer; and
an odometer.

More preferably, the at least one acceleration sensor is adapted for continuously detecting the acceleration data on three perpendicular axes of the vehicle when in motion and transmitting it to the central unit.

Preferably, the monitoring device comprises a data transmission and receiving module connected to the central unit.

More preferably, the data transmission and receiving module is provided with a wireless data transmission interface, preferably a GPRS/UMTS module.

Preferably, the monitoring device comprises local memory means.

Preferably, the monitoring device comprises at least one sound and/or visual signalling element.

More preferably, the sound signalling element comprises a loud speaker to communicate messages through voice synthesis and/or an alarm siren.

More preferably, the visual signalling element comprises a display or at least one luminous indicator, preferably an LED indicator light.

Preferably, the central unit is connected to at least one buffer battery.

Such a provision advantageously makes it possible to ensure the operation of the device even in the case of a loss event that has caused the detachment from an external power source, like for example the battery of an automobile.

Preferably, the at least one significant signal for identifying a loss event involving the vehicle comprises at least one image of the inside and/or outside of the compartment of the vehicle.

Preferably, the at least one significant signal for identifying a loss event involving the vehicle comprises at least one from:

A sound signal detected inside the compartment of the vehicle;

A motion signal of the vehicle detected with the vehicle turned off and closed;

A location signal;

An acceleration signal;

A speed signal;

A distance travelled signal.

Preferably, there is a step consisting of storing the significant signal for identifying a loss event in local memory means.

Preferably, there is a step consisting of segmenting the at least one image detected into a plurality of image portions each relative to the framing of a distinct part of the vehicle.

More preferably, the segmentation of the at least one image detected is carried out during the initial calibration as a function of the luminosity of the single portions of image, by associating the volume inside the passenger compartment with the less luminous image portions and the windows with the more luminous image portions.

Alternatively, the segmentation of the at least one image detected is carried out during initial calibration based on predetermined patterns as a function of the type and/or size of the vehicle.

Even more preferably, the image is segmented into a first upper central portion of the image, relative to the rear window, two side portions of the image, relative to the side windows and a lower central portion of the image, relative to the volume inside the compartment of the vehicle.

Preferably, the portions of image are analysed through a video control algorithm.

More preferably, at least one first portion of the plurality of image portions is processed according to a loitering algorithm and/or at least one second portion of the plurality of image portions is processed according to a human tracking algorithm.

Even more preferably, the image portions identified during calibration as more luminous are processed according to the loitering algorithm and/or the image portions identified during calibration as less luminous are processed according to the human tracking algorithm.

Even more preferably, the first upper central portion of the image relative to the rear window and the two side portions of the image relative to the side windows are processed according to the loitering algorithm.

Similarly, the lower central portion relative to the volume inside the passenger compartment is processed according to the human tracking algorithm.

Preferably, the at least one significant signal for identifying a loss event involving the vehicle comprises a sound signal detected inside the compartment of the vehicle and/or a motion signal of the vehicle.

More preferably, a first static loss event is identified when the loitering algorithm identifies the presence of a shape inside the portion of image associated with the windows for a time greater than a predetermined threshold time and the sound signal and/or the motion signal exceeds a respective first predetermined minimum threshold; or if the sound signal and the motion signal detected both exceed a respective first predetermined average threshold; or if at least one from the sound signal and/or the motion signal detected exceeds a respective first predetermined maximum threshold.

In an equally preferred manner, a second static loss event is identified when the human tracking algorithm identifies the presence of a shape inside the portion of image associated with the inside of the passenger compartment; or the sound signal and the motion signal detected both exceed a respective second predetermined average threshold; or if at least one from the sound signal and/or the motion signal detected exceeds a respective second predetermined maximum threshold.

Preferably, the sound signal and/or the motion signal are time-averaged.

More preferably, the sound signal and/or the motion signal are time-averaged according to a sliding time window algorithm.

Preferably, it includes the step of transmitting a notification signal and/or activating an engine block and/or activating a sound signal in the case in which the first and/or second static loss event has been identified.

Preferably, it includes the step consisting of providing the history of the significant signal for identifying a loss event stored in the local memory means in the case in which a dynamic or static loss event has been identified.

More preferably, the history of the signal provided comprises the images relative to the outside and/or inside of the compartment of the vehicle collected during a time window straddling the moment in time in which the loss event took place.

Preferably, it includes the step of making an emergency call in the case in which a dynamic loss event has been identified.

More preferably, along with the emergency call, the history of the signal made available is transmitted.

Advantageously, this makes it possible to see the situation and how serious the loss event is in order to define the type and amount of emergency services to send.

Preferably, it includes the steps of

comparing the average speed of the vehicle determined based on the speed signal averaged over time, with a predetermined threshold value and,

in the case in which the average speed exceeds such a threshold value, requesting the speed limit value for the current position of the vehicle;

comparing the average speed with the speed limit value;

activating a sound and/or visual signal to the driver in the case in which the average speed is above the speed limit value.

Preferably, it includes the step of detecting one or more of the parameters comprised in the group consisting of:

number of kilometres travelled;

instantaneous position of the vehicle;

driving data of the vehicle;

driving time of the vehicle.

Further characteristics and advantages of the present invention will become clearer from the following detailed description of some preferred embodiments thereof, made with reference to the attached drawings.

The different characteristics in the single configurations can be combined as desired according to the above description, if it is necessary to have advantages resulting specifically from a particular combination.

In such drawings,

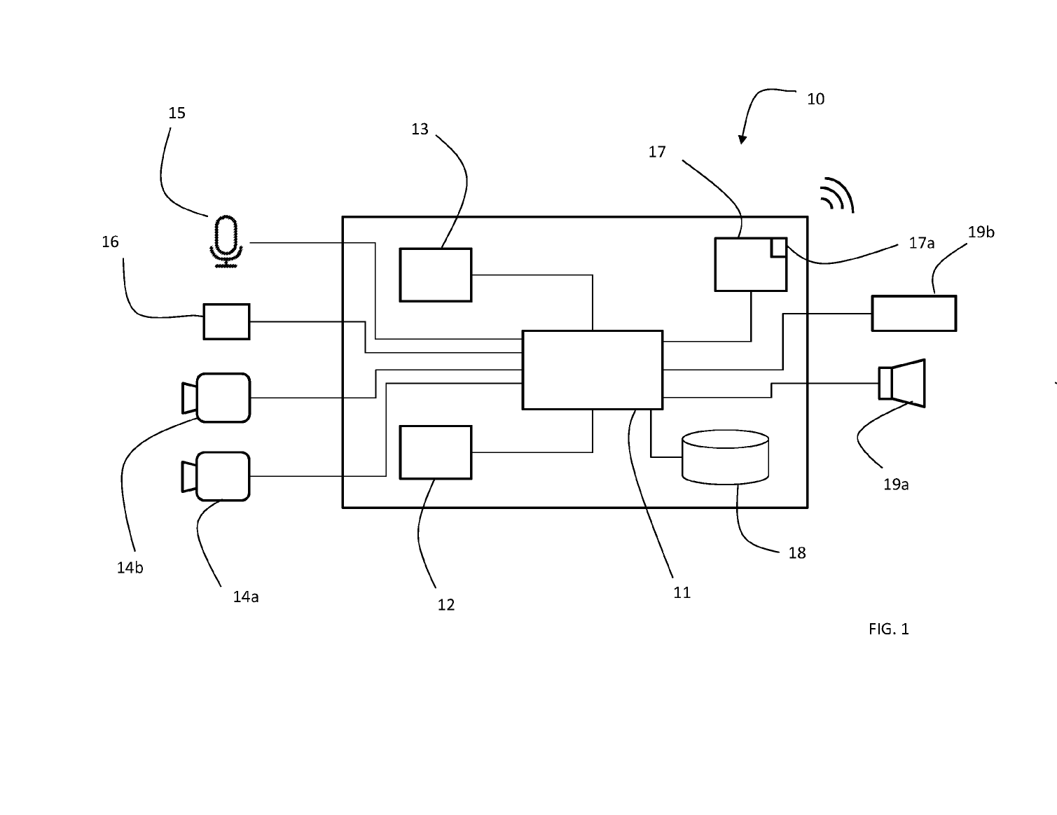

FIG. 1 is a schematic block diagram of a preferred embodiment of the device for monitoring a vehicle according to the present invention;

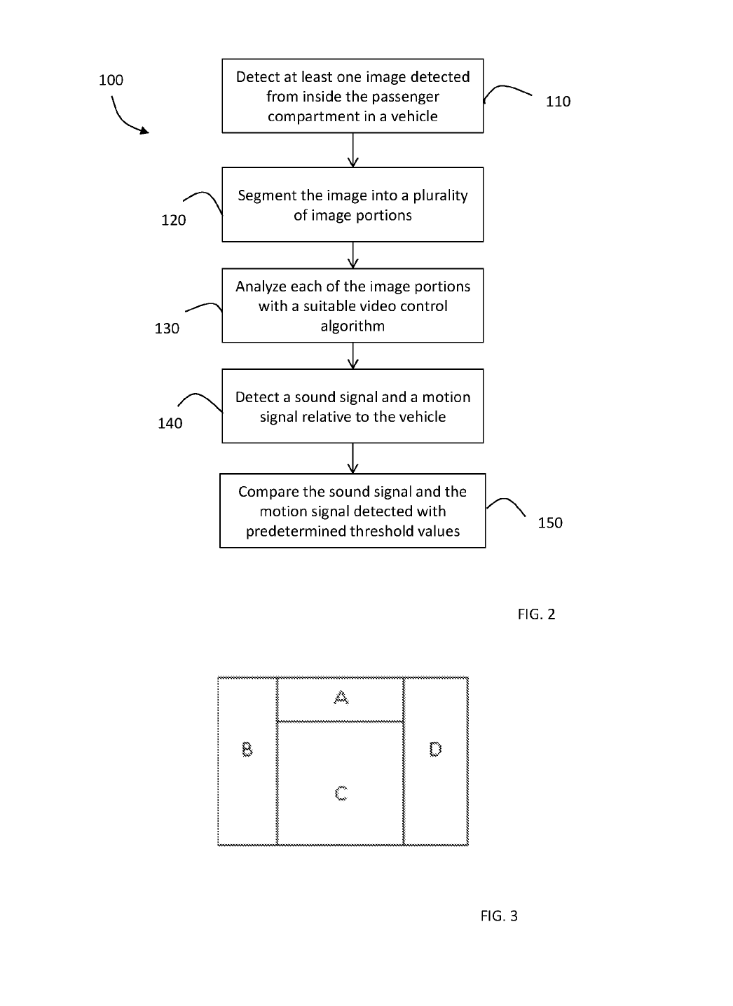

FIG. 2 is a block diagram of the main steps for monitoring and identifying a static loss event, able to be implemented based on the method for monitoring a vehicle according to the present invention;

FIG. 3 is a schematic representation of segmentation of a video image carried out in accordance with the present invention.

In the following description, in order to illustrate the figures, identical reference numerals or symbols are used to indicate constructive elements with the same function. Moreover, for the sake of clarity of illustration, some references could not be repeated in all of the figures.

With reference to FIG. 1, a preferred embodiment of the device for monitoring a vehicle, according to the present invention, particularly suitable for monitoring an automobile, is shown wholly indicated with 10.

The monitoring device 10 comprises a central unit 11 connected to a plurality of sensors 12,13,14a,14b,15,16 adapted for detecting at least one significant signal for identifying a loss event, wherein the central unit 11 comprises means for processing the signals detected by the plurality of sensors 12,13,14a,14b,15,16 in order to identify the occurrence of a loss event.

In the preferred embodiment illustrated, the plurality of sensors comprises a location sensor 12 capable of receiving information on its own geographical coordinates and providing them to the central unit 11, such as a GPS receiver.

The plurality of sensors also comprises an acceleration sensor 13 adapted for continuously detecting the acceleration data on three perpendicular axes of the vehicle when in motion and transmitting it to the central unit 11, in order to record the dynamic behaviour of the vehicle. Such data proves particularly useful for identifying the occurrence and for the reconstruction of the dynamics of an accident, providing indications on the way in which the impact occurred.

In accordance with the present invention, the plurality of sensors additionally comprises at least one inner video camera 14a,14b adapted for detecting images from inside the compartment of the vehicle (i.e. framing the images from inside the compartment) and transmitting them to the central unit 11. In the embodiment illustrated as an example the compartment inside the vehicle is the passenger compartment of the automobile.

In the illustrated preferred embodiment there are two inner video cameras 14a,14b.

A first inner video camera 14b is positioned so as to frame the inside of the passenger compartment of the vehicle. Such an inner video camera 14b is preferably positioned so as to frame also at least part of the perimeter of the passenger compartment from the inside.

Specifically, in the automobile, the preferred position is at the rear-view mirror with the lens directed towards the rear of the vehicle so as to monitor the windows of the automobile, wherein, specifically, the term windows of the automobile also includes the rear window. For this purpose, a video camera provided with a wide-angle lens is advantageously used. In this way, part of the outside of the automobile in close proximity to the outer perimeter thereof is monitored at the same time.

However, it is possible, possibly in addition, to provide for a second inner video camera 14a positioned with the lens facing towards the front windscreen, preferably also arranged at the rear-view mirror.

Alternatively, it is possible to provide for the use of a fish-eye video camera capable of detecting images in 360°, making the use of a second inner video camera superfluous in order to detect images of the entire perimeter of the passenger compartment and therefore of the entire perimeter outside the automobile.

The inner video cameras 14a,14b prove particularly useful in early identification of a loss event involving a parked vehicle, as well as in detecting the presence of people or animals inside the passenger compartment once the vehicle has been left, i.e. with the vehicle turned off and closed.

For example, the inner video cameras 14a,14b, positioned so as to detect images of the outside of the vehicle, contribute to early identification of possible tampering or break-in, allowing a possible attempted theft to be identified in time, hopefully even before any damage has been caused to the vehicle.

The inner video cameras 14a,14b also prove useful in the reconstruction of the dynamics of an accident.

In the illustrated preferred embodiment, the plurality of sensors also comprises a sound sensor 15, like for example a microphone, preferably arranged inside the vehicle in order to detect internal noises.

Preferably, in the illustrated embodiment particularly suitable for monitoring an automobile, the sound sensor 15 is positioned inside the passenger compartment. In this case a high-sensitivity sound sensor 15 is preferably used in order to also capture sounds coming from the outside, around the vehicle.

The sound sensor 15 can also act as an interface for introducing commands or voice messages.

Last but not least, in the illustrated preferred embodiment, the plurality of sensors also comprises a motion sensor 16 activated in particular with the vehicle turned off and closed to monitor movements or oscillations of the vehicle linked to a static loss event, such as a theft or an act of vandalism.

The additional information concerning the movement or the presence of noises above certain thresholds further facilitates the early identification of static loss events, further increasing accuracy.

The monitoring device 10 according to the illustrated embodiment also comprises a data transmission and receiving module 17 connected to a central unit 11 and preferably provided with a wireless data transmission interface 17a, like for example a GPRS/UMTS module. In this way, it is possible to receive the data collected by the central unit 11 and transfer it to a server arranged remotely.

In addition, in the illustrated preferred embodiment, there are local memory means 18 in which at least part of the history of the data collected is saved. Such a memory 18 is cyclically overwritten with more recent data, once the entire memory capacity has been exploited. The size of the local memory means 18 is such as to allow the storage of a history comprising at least about 60 events each for example lasting approximately 30 seconds.

The monitoring device of FIG. 1 also comprises at least one sound signalling element 19a and/or visual signalling element 19b. The term sound signalling element 19a means for example a load speaker to communicate messages through voice synthesis and/or an alarm siren, whereas the term visual signalling element 19b means, as an example and not for limiting purposes, one or more from a display capable of displaying text and/or graphical messages, one or more luminous indicators such as LED indicator lights and so on.

The monitoring device 10 according to the present invention additionally comprises a plurality of further sensors (not illustrated) adapted for detecting the driving parameters like for example a speedometer and an odometer for determining the driving speed and the partial number of kilometres travelled by the vehicle, possibly associating them with time data provided by the location sensor 13.

The operation of the monitoring device 10 of a vehicle according to the present invention is as follows.

The central unit 11 cyclically or continuously receives the data collected by the plurality of sensors 12,13,14a,14b,15,16 adapted for detecting at least one significant signal for identifying a loss event.

In particular, the images detected by the inner video cameras 14a,14b are processed, linking them with at least part of the data detected by the remaining sensors 12,13,15,16.

Specifically, for the reconstruction of a dynamic loss event, the central unit 11 takes the images collected during a time window straddling the moment at which the event took place from the memory means 18 and makes them available. The images detected and made available can advantageously be used by insurance workers in order to verify the hypothesised dynamics compatible with the acceleration data recorded by the acceleration sensor 13, in this way managing to reconstruct in a substantially certain and unequivocal manner the dynamics of an accident. The moment at which a dynamic loss event takes place can be determined in a known way through suitable crash-detection algorithms based on the data detected by the acceleration sensor 13.

With reference to the illustrated embodiment of the monitoring device 10, the images taken by the inner video camera 14a oriented towards the windscreen of the vehicle prove particularly suitable for the reconstruction of frontal impacts, whereas the images recorded by the inner video camera 14b positioned so as to frame the side windows and the rear window of the vehicle are particularly useful for the reconstruction for example of a rear-ending collision.

Once a dynamic loss event has been identified, the monitoring device 10 activates an emergency call through the data transmission and receiving module 17, possibly transmitting the images recorded through the inner video cameras 14a,14b straddling the moment at which the loss event took place.

The monitoring and identification 100 of a static loss event is illustrated in example terms in FIG. 2. The images taken (step 110) by the inner video camera 14b oriented towards the side windows and the rear window are segmented (step 120) into a plurality of image portions A, B, C, D as shown in FIG. 3, each relative to the framing of a specific part of the vehicle.

In the specific embodiment illustrated in FIG. 3, the image framed by the inner video camera 14b facing towards the rear of the vehicle is divided into a first upper central portion A relative to the rear window, two side portions C, D relative to the windows and a lower central portion C corresponding to inside the passenger compartment. The segmentation of the image into the relative portions takes place during calibration automatically as a function of the respective luminosity or, alternatively, based on predetermined patterns selected as a function of the type and size of the vehicle.

All of the image portions A, B, C, D are analysed through a specific video control algorithm.

Specifically, for early identification of a theft event, the image portions relative to the rear window A and to the windows B, D are analysed (step 130) through a loitering algorithm i.e., in general terms, an algorithm that carries out an analysis of the significant movements that take place within a framed scene. Through the application of such an algorithm to the framing of the rear window and of the windows of the automobile, it is possible to detect the presence, in the portions of image analysed, of a human shape for a predetermined time period. The analysis of the images detected is carried out taking into account the presence of the upright between the two windows and the fact that the human shape could be partial considering the height and the dimensions of the windows and of the rear window.

Somebody loitering close to a parked and empty car can, indeed, be an indication of a probable theft about to occur, since, in the preliminary steps directly before a theft, the thief generally inspects the vehicle from the outside in order to evaluate how to open and remove things from the vehicle.

Preferably, as well as the analysis of a human shape loitering in the portions of image relative to the windows and/or to the rear window, the monitoring device 10 analyses (step 140) the inner audio detected through the sound sensor 15 and/or the signal coming from the motion sensor 16. Both for the audio signal, and for the motion signal plurality of first thresholds is set. Preferably, three respective first thresholds are set: a first minimum threshold, a first average threshold and a first maximum threshold.

For a more reliable evaluation of the sound signal and/or of the motion signal, the input signals are time-averaged. For this purpose, a sliding time window algorithm is preferably used that carries out an analysis over a predetermined time period. Such a time period, although of predetermined length, slides over time. The threshold is considered to be exceeded if the average of the samples in the period considered exceeds the predetermined value.

The situation of a possible attempted theft is identified when the loitering algorithm identifies a human shape that loiters in at least one image portion A, B and/or D analysed and at least one of the two further measurements (audio and/or motion) averaged over time has exceeded the respective first minimum threshold.

In addition, in the absence of identification of a situation of potential danger by the loitering algorithm applied to the portions of image detected by the inner video camera 14b, a situation of probable attempted theft is still identified (step 150) when:

the audio signal and the motion signal detected have exceeded the respective first average threshold, or;

if at least one from the audio signal or the motion signal detected has exceeded the respective first maximum threshold.

Once a theft event has been identified, the monitoring device 10 transmits a notification signal through the data transmission and receiving module 17, also activating the engine block and the sound siren signalling element 19a.

Once the monitoring device 10 has received a signal of a theft event, through the data transmission and receiving module 17 it is possible to connect remotely to the device itself 10 in order to receive the images detected by the inner video cameras 14a and/or 14b of the device 10 and the audio signal detected by the sound sensor 15 in real time, thus being able to evaluate the situation signalled.

To identify an event of accidentally leaving children or animals in the vehicle, the image portion relative to the passenger compartment C is analysed applying a specific human tracking algorithm that analyses the data in order to identify in the image portion a shape of children or animals, characterised by a smaller size than what is typical of an adult (step 130).

Preferably, as well as the analysis of presence of a shape of small size in the image portions C relative to the passenger compartment, the monitoring device 10 analyses (step 140) the inner audio detected through the sound sensor 15 and/or the signal coming from the motion sensor 16. Both for the audio signal and for the motion signal, a plurality of second respective thresholds is set, not necessarily coinciding with the first thresholds set for identifying a theft event. Preferably, three respective second thresholds are set: a second minimum threshold, a second average threshold and a second maximum threshold.

Also in this case, for a more reliable evaluation of the sound signal and/or of the motion signal, the input signals are time-averaged.

The situation of presence of a child or animal in an unattended vehicle is identified when, in conditions of the vehicle being switched off and closed, the human tracking algorithm has detected a shape of a child or animal in the image portion C framed by the inner video camera 14b.

In addition, in the absence of identification of presence of children or animals on board a vehicle that is switched off and closed by the human tracking algorithm applied to the portions of images detected by the inner video camera 14b, a situation of probable unattended children or animals on board a vehicle is still identified (step 150) when:

the audio signal and the motion signal detected have exceeded the respective second average threshold, or;

if at least one from the audio signal or the motion signal detected has exceeded the respective second maximum threshold.

Once an event of an unattended child or animal in the vehicle has been identified, the monitoring device 10 transmits a notification signal through the data transmission and receiving module 17, also activating the sound siren signalling element 19a.

The monitoring device 10 also implements a plurality of driving assistance activities based on the data detected through the plurality of sensors 13,14a,14b,15,16.

For example, based on the driving parameters detected including the average speed determined through the sliding time window algorithm, the acceleration, the number of kilometres travelled, the areas travelled through, and so on, the central unit 11 activates a plurality of voice signals aimed at the driver.

As an example, in the case in which the average speed determined based on the sliding time window algorithm exceeds a predetermined threshold, the apparatus accesses a database containing information relative to the mapping of the speed limits of the area in order to obtain the speed limit for the current position of the vehicle. Such information can be contained in the local memory means 18 or, acquired from a remote server to which the device is able to connect through the data transmission and receiving module 17. If the limit is below the exceeded threshold, a danger situation is identified which sets off a sound and/or visual warning to the driver.

It is possible to hypothesise further situations that can be detected through the monitoring device 10 according to the present invention, including for example driving while talking on a mobile telephone, dozing, driving in adverse weather conditions, exceeding a distance limit or driving outside of areas or times set by an insurance plan. The identification of one or more of such situations activates a corresponding sound and/or visual warning to the driver.

From the description that has been made, the characteristics of the device and of the method for monitoring a vehicle object of the present invention are clear, just as the relative advantages are also clear.

Further variants of the embodiments described above are possible, without departing from the teaching of the invention.

Finally, it is clear that a device for monitoring a vehicle thus conceived can undergo numerous modifications and variants, all of which are covered by the invention; moreover, all of the details can be replaced by technically equivalent elements. In practice, the materials used, as well as the sizes, can be whatever according to the technical requirements.

1. A device for monitoring a vehicle provided with an inner compartment at least partially delimited by a plurality of windows, the monitoring device comprising a central unit connected to a plurality of sensors adapted to detect at least one significant signal for identifying a loss event involving the vehicle, said plurality of sensors comprising at least one inner video camera adapted to detect images inside and/or outside the inner compartment framed from the inside of the vehicle compartment and transmit them to the central unit, characterised in that the central unit comprises means for processing the signals detected by the plurality of sensors adapted to identify the occurrence of a loss event based on at least the signal detected by the at least one inner video camera.

2. The device for monitoring a vehicle according to claim 1, wherein the at least one inner video camera is adapted to be installed so as to capture at least part of the plurality of windows delimiting the compartment of the vehicle in order to capture at least part of the area outside the vehicle from inside the compartment.

3. The device for monitoring a vehicle according to claim 1, wherein the at least one inner video camera is adapted to be installed so as to capture at least part of the inside of the compartment of the vehicle.

4. The device for monitoring a vehicle according to claim 1, wherein the plurality of sensors comprises at least one first and a second inner video camera, wherein the first inner video camera is adapted to be installed so as to film, from inside the compartment of the vehicle, at least part of the side windows and of the rear window laterally and rearwardly delimiting the compartment of the vehicle, and the second inner video camera is adapted to be installed so as to film, from inside the compartment of the vehicle, at least part of the front windscreen frontwardly delimiting the compartment of the vehicle.

5. The device for monitoring a vehicle according to claim 1, wherein the plurality of sensors comprises at least one sound sensor adapted to be installed inside the compartment of the vehicle.

6. The device for monitoring a vehicle according claim 1, wherein the plurality of sensors comprises at least one sensor selected from the group consisting of:
a movement sensor;
a location sensor;
an acceleration sensor;
a speedometer; and
an odometer.

7. A vehicle provided with an inner compartment at least partially delimited by a plurality of windows characterised in that it comprises a monitoring device of a vehicle according to claim 1.

8. A method for monitoring a vehicle provided with an inner compartment at least partially delimited by a plurality of windows comprising the steps of detecting at least one significant signal for identifying a loss event involving the vehicle, and identifying a loss event based on the at least one signal detected, wherein the at least one significant signal for identifying a loss event involving the vehicle comprises at least one video image taken from the inside and/or outside of the inner compartment framed from the inside of the vehicle compartment.

9. The method for monitoring a vehicle according to claim 8, wherein the at least one significant signal for identifying a loss event involving the vehicle comprises at least one video image of the area inside and/or outside the compartment of the vehicle.

10. The method for monitoring a vehicle according to claim 8, comprising the step of segmenting the at least one video image detected into a plurality of video image portions, each relative to picturing a distinct part of the vehicle.

11. The method for monitoring a vehicle according to claim 10, wherein the segmentation of the at least one video image detected is carried out in the initial calibration step as a function of the luminosity of the single video image portions, associating the volume inside the passenger compartment with the least luminous video image portions and associating the windows with the most luminous video image portions or based on predetermined patterns as a function of the type and/or the size of the vehicle.

12. The method for monitoring a vehicle according to claim 10, wherein at least one first portion of the plurality of video image portions is processed according to a loitering algorithm and/or at least one second portion of the plurality of video image portions is processed according to a human tracking algorithm.

13. The method for monitoring a vehicle according to claim 12, wherein the at least one significant signal for identifying a loss event involving the vehicle further comprises a sound signal detected from inside the compartment of the vehicle and/or a movement signal of the vehicle.

14. The method for monitoring a vehicle according to claim 13, wherein a first static loss event is identified when the loitering algorithm identifies the presence of a shape inside the portion of video image associated with the windows for a time longer than a predetermined threshold time and the sound signal and/or the movement signal exceeds a respective first predetermined minimum threshold; or if the sound signal and the movement signal detected both exceed a respective first predetermined medium threshold; or if at least one from the sound signal and/or the movement signal detected exceeds a respective first predetermined maximum threshold.

15. The method for monitoring a vehicle according to claim 13, wherein a second static loss event is identified when the human tracking algorithm identifies the presence of a shape inside the portion of video image associated with the inside of the passenger compartment; or if the sound signal and the movement signal detected both exceed a respective second predetermined medium threshold; or if at least one from the sound signal and/or the movement signal detected exceeds a respective second predetermined maximum threshold.

16. The method for monitoring a vehicle according to claim 8, wherein the at least one significant signal for identifying a loss event involving the vehicle further comprises a sound signal detected from inside the compartment of the vehicle and/or a movement signal of the vehicle.
